(19) United States
(12) Patent Application Publication
(10) Pub. No.: US 2006/0031570 A1
(43) Pub. Date: Feb. 9, 2006

(54) Network establishment and management protocol

(76) Inventors: Robin J. Blackwell, SURREY (GB); Neil A. Hankin, Smallfield (GB); Nicoll B. Shepherd, Coulsdon (GB); Philip A. Rudland, Horley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/523,391

(22) PCT Filed: Jul. 24, 2003
(86) PCT No.: PCT/IB03/03303

§ 371 Date: Feb. 1, 2005

(30) Foreign Application Priority Data
Aug. 6, 2002 (GB) 0218174.1

(51) Int. Cl. G06F 15/173

(52) U.S. Cl. 709/238

(57) ABSTRACT

The invention relates to bridging between networks. One network uses a composite device type with a number of sub-devices. In response to a device description query from a first network device (202) a bridge device (206) responds with a message indicating its device type as being the composite device type and the number of sub-devices being the number of devices in the second network.

This invention relates to a network protocol, and in particular to implementations of the protocol.

A prior art protocol for network management is universal plug and play (UPnP), which is very useful for internet applications where bandwidth, battery consumption, and to an extent cost, are not an issue. Implementations of the protocol in consumer electronics (CE) do exist, but because of the extent of the protocol, such implementations impose a heavy load especially on the simplest devices that otherwise would require only minimal processing capability.

The need therefore exists for a protocol suitable for embedding in simple devices such as lights, thermostats and CE equipment (remote control for TV's, DVD's and PVR's), that is simple and cost effective to implement, requires the minimum of bandwidth, yet is scalable across a range of devices with varying capabilities.

This need is not restricted to wireless application, but extends to wired applications.

According to a first aspect, there is provided a method of operating a bridge device between first and second networks, there being a plurality of first network devices in the first network, a plurality of second network devices in the second network, one of the network devices being a bridge device in both the first and second networks, wherein the first network uses message signals including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice; the method including:
receiving a device description query in the bridge device from the first network;
responding to the device description query with a device description message including the description of the bridge device as being of a composite device type and a value representing the number of other devices in the second network;
receiving at least one further device description query from a device in the first network relating to one of the other devices in the second network;
responding to the or each further device description query with a device description message including a description of the other device; and
forwarding in the first network further messages to or from devices in the second network from or to devices in the first network respectively as messages to or from the respective subdevice of the bridge device;
whereby network devices in the second network appear to network devices in the first network as sub-devices of the bridge device of composite device type.

According to the invention, devices in the first network use a composite device type to act as a very simple way of accessing devices in the second network. The bridge simply appears as a composite device to the first network, and the individual devices in the second network appear as sub-devices of the bridge. Thus, most devices in the network can readily access devices in the second network. At the lowest level the bridge appears on each of the networks as a single physical address. When a device discovers the bridge address it first, as always, requests device information through the Get Simple Description request. The bridge responds directly to this and identifies itself as a Composite Device and returns the number of devices located on the ‘other side’ of the bridge.

Further queries are then made to the bridge requesting the Simple Device Description for each of the ‘pseudo’ embedded devices, just as if it were any other composite device. The requests and subsequent commands are all identified as being for a specific embedded device within the bridge however they are then forwarded on by the bridge to a specific device located on the ‘other side’.

The bridge is not quite a normal composite device since in preferred embodiments the number of embedded devices that it contains may change; it is a Dynamic Composite. The bridge identifies the number of embedded devices as a part of the standard response to a Get Simple Description request, but this is the instantaneous number of devices located on the other side of the bridge. The Dynamic Composite bridge also exposes an attribute to the first network that identifies the number of devices in the second network, so that devices in the first network can query this at any time. If the bridge supports event subscription, devices can also subscribe to changes in this attribute so as they are informed when the number of devices changes.

In embodiments, the networks use a protocol that is described in this patent application as well as other patent applications claiming the same earliest priority. The protocol itself will be referred to as home uniform control language (HUCL).

This patent application is specifically concerned with bridging, i.e. links between networks whether those networks are HUCL networks or not.

In embodiments, the method includes:
receiving a device description query in the bridge device from the second network;
responding to the device description query with a device description message including the description of the bridge device as being of a composite device type and a value representing the number of other devices in the first network;
receiving at least one further device description query from a device in the second network relating to one of the other devices;
responding to the or each further device description query with a device description message including a description of the other device; and
forwarding in the second network further messages to or from devices in the first network from or to devices in the second network respectively as messages to or from the respective subdevice of the bridge device;
whereby network devices in the first network appear to network devices in the second network as sub-devices of the bridge device of composite device type.

In another aspect, the invention relates to the bridge device itself. Accordingly, the invention also relates to a bridge device for linking first and second networks, there being a plurality of first network devices in the first network, a plurality of second network devices in the second network, wherein the first network uses message signals including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice; the bridge device comprising:
a transceiver for communicating with other devices in the first network;
a transceiver for communicating with other devices in the second network;
and a message handler arranged:
to receive a device description query in the bridge device from the first network and to respond to the device description query with a device description message including the description of the bridge device as being of a composite device type and a value representing the number of other devices in the second network;
to receive at least one further device description query from the first network relating to one of the other devices; and to respond to the or each further device description query with a device description message including a description of the other device as a corresponding sub-device; and
to forward in the first network further messages to or from devices in the second network from or to devices in the first network respectively as messages to or from the respective subdevice of the bridge device;
whereby network devices in the second network appear to network devices in the first network as sub-devices of the bridge device of composite device type.

In embodiments, the transceivers for connecting to the first and second networks are distinct, though in alternative arrangements the transceivers may share somel components, for example a single antenna, or indeed one transceiver may be used for radio frequency communication with both networks.

The invention also, in a further aspect, relates to a system comprising:
a first network including a plurality of first network devices, wherein the first network uses message signals including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice;
a second network including a plurality of second network devices;
wherein one off the network devices is a bridge device in both the first and second networks; the bridge device comprising:
a first transceiver for communicating with other devices in the first network;
a second transceiver for communicating with other devices in the second network;
and a message handler arranged:
to receive a device description query in the bridge device from the first network and to respond to the device description query with a device description message including the description of the bridge device as being of a composite device type and a value representing the number of other devices in the second network;
to receive at least one further device description query from the first network relating to one of the other devices; and to respond to the or each further device description query with a device description message including a description of the other device as a corresponding sub-device; and
to forward in the first network further messages to or from devices in the second network from or to devices in the first network respectively as messages to or from the respective subdevice of the bridge device so that network devices in the second network appear to network devices in the first network as sub-devices of the bridge device of composite device type.

The number of devices in the second network may not be constant and the bridge device may accordingly be arranged to respond to a device description query from the first network with the instantaneous number of devices in the second network.

The invention also relates to a computer program arranged to control a networked bridge device to carry out the method as set out above. The computer program may in particular be recorded on a data carrier.

For a better understanding of the invention, embodiments will now be described purely by way of example, with reference to the accompanying drawings in which:

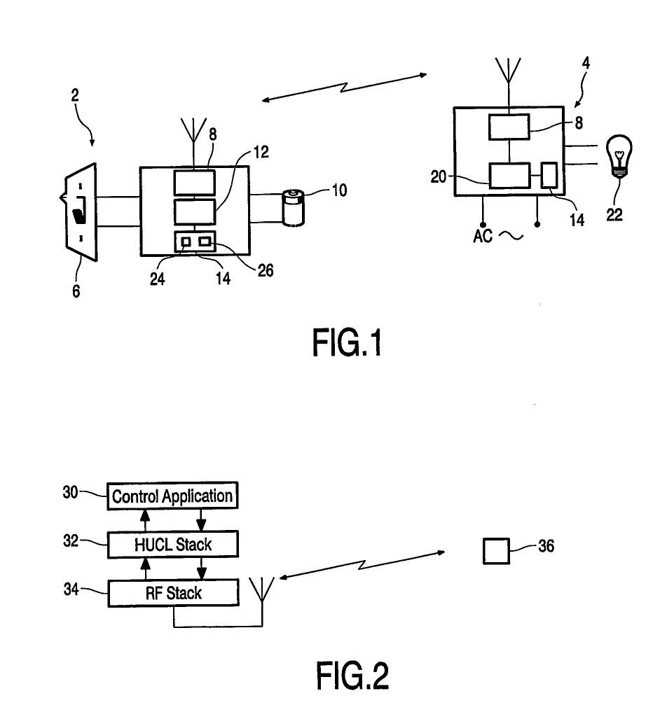

FIGS. 1 to 10 illustrate the HUCL generally for a better understanding of the background, and specifically

FIG. 1 shows a pair of devices communicating using HUCL;

FIG. 2 shows a schematic of the software in one device in HUCL;

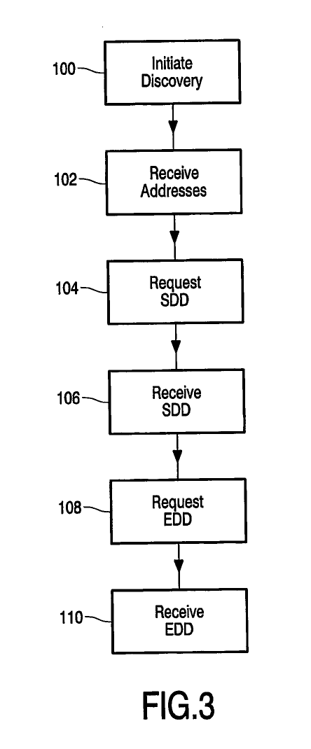

FIG. 3 is a flow diagram of the device discovery process;

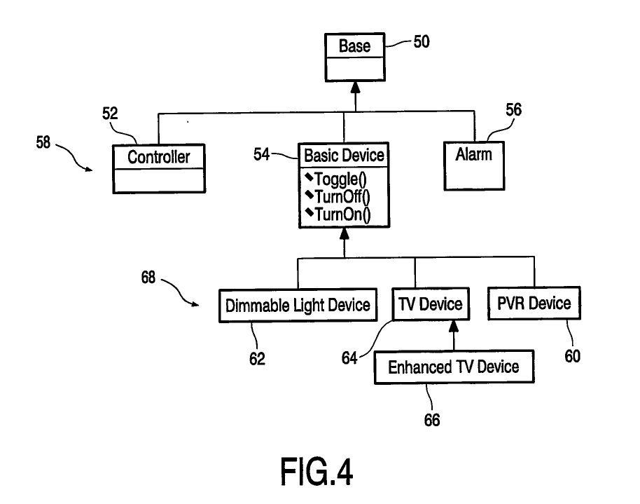

FIG. 4 is a schematic of the device type hierarchy;

FIG. 5 shows the steps that a controller carries out to inform a controlled device of its control capability of that device;

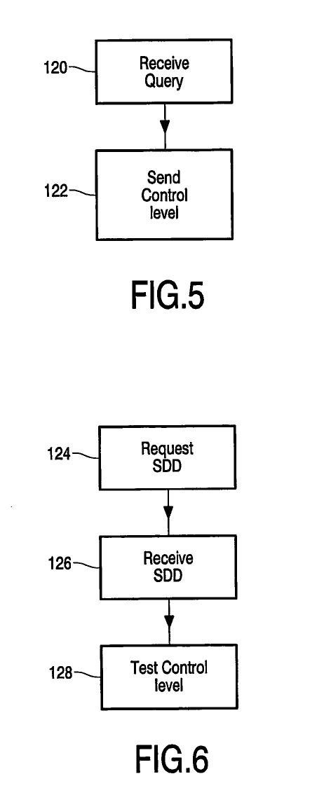

FIG. 6 shows the steps that a controller carriers out to determine its control capability of a controlled device;

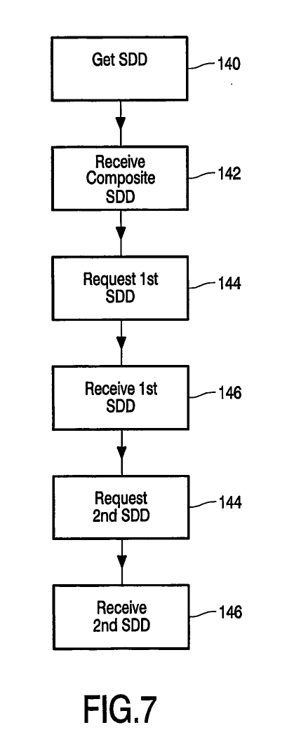

FIG. 7 is a flow diagram of the device discovery process for a composite device;

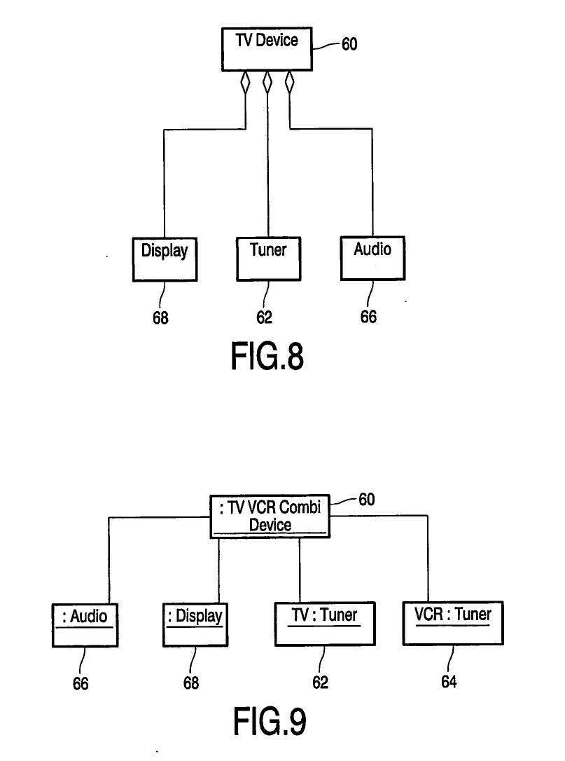

FIG. 8 illustrates a composite device;

FIG. 9 illustrates another composite device; and

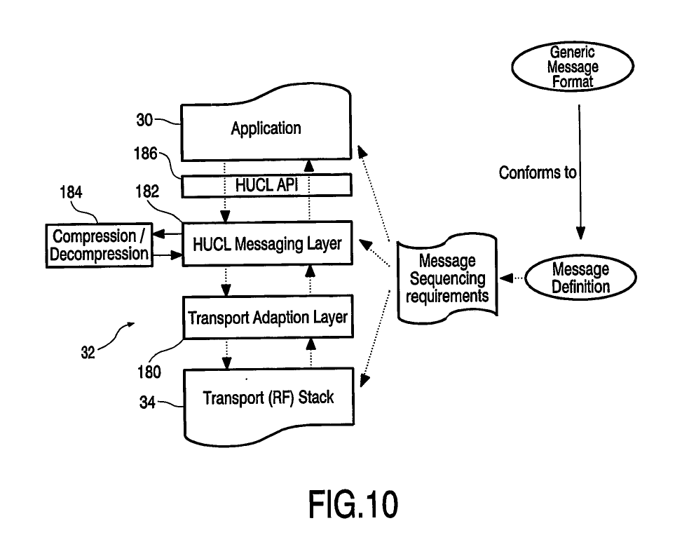

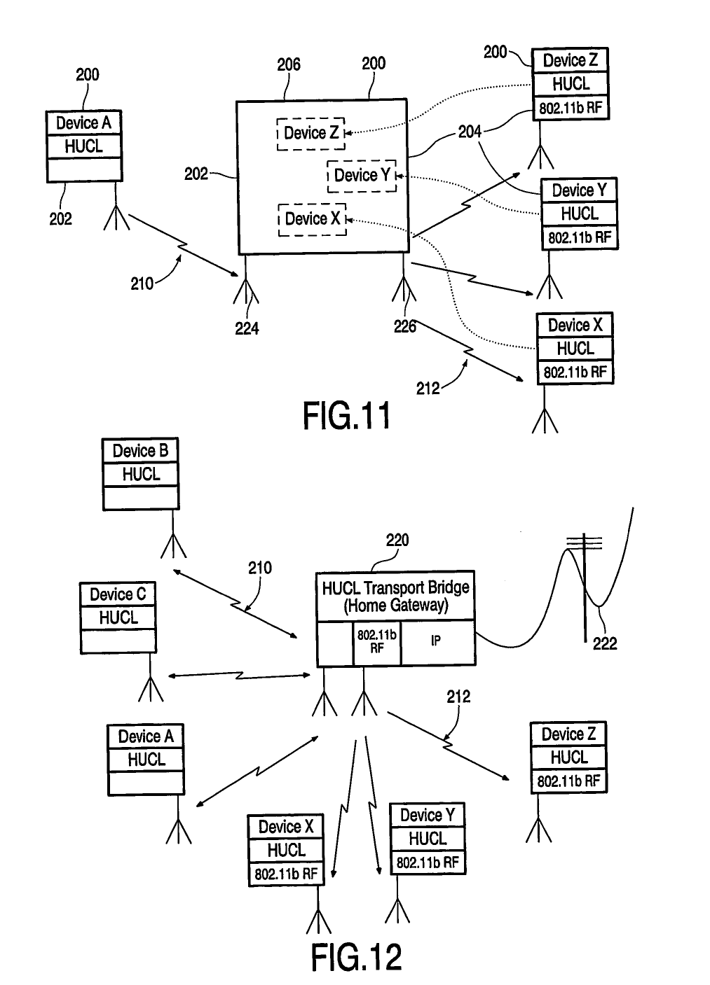

FIG. 10 shows the structure of the software; and FIGS. 11 to 13 illustrate specific embodiments of the invention including a bridge, in which;

FIG. 11 shows an embodiment of a system having a bridge device;

FIG. 12 shows an embodiment of a system connected to the internet; and

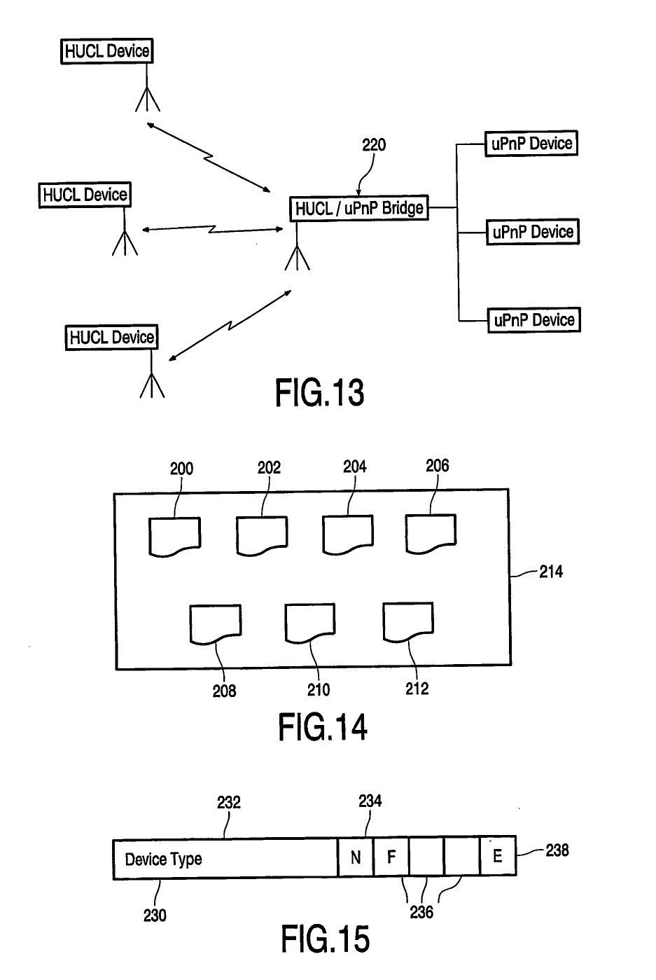

FIG. 13 shows an embodiment of a system having a bridge device between a network according to the invention and another network;

FIG. 14 illustrates the HUCL protocol; and

FIG. 15 illustrates a simple device description message.

Although the present invention relates to bridge methods and apparatus, before these are described details of the HUCL protocol and corresponding devices, systems and methods will first be described with reference to FIGS. 1 to 10 and 15 to put the invention into context.

The protocol HUCL is a lightweight, low bandwidth control protocol primarily designed for wireless systems. The messaging format is based on XML, and messages are compressed prior to transmission. The use of XML provides an extensible and scalable solution with the compression reducing the data sent, so reducing the amount of time the transmitter is on and consuming power.

The general principles of the HUCL protocol and how it would operate on a device will now be discussed with reference to a simple example.

Referring to FIG. 1, a light switch 2 and a light fitting 4 are provided. The light switch 2 has a physical rocker switch 6 operated by the user, together with an RF transceiver 8 and battery 10, together with control circuitry 12 and memory 14. The light fitting also has an RF transceiver 8 and memory 14, but is mains powered and has the control circuitry 20 to apply power to the light bulb 22. The light switch 2 is thus an example of a controller which has a control input 6 (the switch), whereas the light fitting is an example of a controlled device 4. The memory 14 in the controller includes a list 24 of device types that the controller can control, and control functions appertaining to the device types. The memory 14 in both controlled 4 and controller 2 devices also contains code 26 for causing the control circuitry to carry out the methods that will be described in more detail below.

FIG. 2 shows a representation of the software that resides on each of the devices in memory 14. The control application 30 communicates with the HUCL Software Stack 32 when certain events occur.

In a similar way the HUCL Software Stack 32 communicates with the RF Software Stack 34, and the RF Software Stack 34 will communicate back to the HUCL Software Stack 32 when certain events occur e.g. on receipt of data.

Messages 36 are sent and received. The messages may be of a number of types, including a simple device description query message, or any of a number of other message types.

The operation of the devices will now be described with reference to FIG. 3. The first phase in the operation of this pair of devices is for the switch to discover the address of the fitting. This is known as device discovery, and it is a requirement of the underlying RF transport stack that device discovery is either provided (in the RF Software Stack), or that it is possible to implement device discovery on top of the transport stack (in the lower layer of the HUCL Software Stack).

The discovery process is initiated 100 by the Control Application (possibly as a result of some user interaction) by performing a call into the HUCL Software Stack requesting firstly the number of known devices, and then the network addresses of those devices. These device addresses are returned.

Depending on the underlying RF protocol, the network addresses may be established in some other way.

The end result of the device discovery phase is that the Control Application is supplied 102 with a list of addresses of all devices known by the RF Stack. At this point in the process the Control Application knows nothing more about each other device other than its address.

The second phase in the pairing process is for the Control Application to gather information on the devices for which it has addresses. This information is called the device description. The control application does this by making a call into the HUCL Software Stack, passing the address of the device that it requires the device description from.

The request for the simple device description is then passed 104 over the RF link to the destination device, so in the switch/fitting example described above the request is transmitted from the switch to the fitting. On receiving the request, the HUCL Software Stack at the destination device makes a call in to the Control Application requesting the device description. The format of the description is defined. If not already in a compressed form the description is compressed before being transmitted back to the sender of the request.

When the HUCL Software Stack on the requesting device receives 106 the device description, it is passed up to the Control Application. At this point the application has some basic information about the device and can make the decision as to whether it wished to communicate further with this device.

A design goal of HUCL is that it is suitable to operate on very simple devices, however the information necessary to fully describing a device is potentially quite complex. The list below shows the sort of information a device might want to provide as part of its description.
Device Type e.g. DVD
Vendor Name e.g. Philips
Model Number e.g. DVD1010/002
Serial Number e.g. AH06848032345
Vendor URL e.g. www.philips.com

For the simplest of control devices, such as the switch used in the example throughout this section, much of this information is probably redundant. It would however be of use on a higher end ‘PDA’ type remote control that has a screen where such information could be displayed to the user.

The processing of such descriptions on low-end devices can present a problem, since it would potentially need the storage (RAM) to cache the complete message as it was received. The problem is worse than it might at first seem, since the overall size of the description data shown above is indeterminate, much of the information is ‘free text’; the vendor name could be very long, the URL could specify an exact page maybe even with parameters e.g. http://www.consumer.philips.com/global/b2c/ce/catalog/subcategory.jhtml?gro upld=VIDEO&divld=0&catld=DVD&subCatld=DVDPLAYER

The way in which this is overcome in HUCL is that the device description is split into two tiers of information. The first tier is a simplistic description of the device but identifying if further information is available. It does not contain any free text fields so the overall length of it is deterministic. The second tier of extended information is optional but provides additional information.

Referring to FIG. 15, the Simple Device Description message 230 includes as fields the device type 232, a field 238 to indicate if Extended Device Description available and other fields 236 identifying key information e.g. a flag to indicate if event subscription is available. Optional integer field 234 represents the number of sub-devices of a composite device. The skilled person will appreciate that the message 230 may also include a header and footer which are omitted for simplicity. The message will include compressed XML tokens which are likewise omitted for clarity. The fields of the Simple Device Description are all of fixed length, so that they can be dealt with readily without decompression.

After receiving 106 (FIG. 3) the Simple Device Description 230 the Simple Device Description 230 is passed back to the HUCL Stack.

If the Extended Device Description is available and the controller device requires it, the controller device Control Application may issue a “GetExtendedDescription” request 108 back to the device.

The HUCL Stack on the device receiving this request makes a Get Extended Description call into the Control Application requesting the Extended Device Description.

The Extended Device Description is passed back to the HUCL Stack, and makes its way back to the Control Application on the device that requested it. The Extended Description is then returned 110 to the requesting device.

If a GetExtendedDescription query is received on a device that does not provide an Extended Device Description the request is simply ignored.

Returning again to the switch/fitting example used throughout this section, from the point when the switch knows only the address of the fitting, the switch requests from the fitting its Simple Device Description. On receiving this it provides sufficient information such that the switch knows that it is talking to a light fitting that conforms to the standard fitting command set, it also knows that (for example) the fitting can't provide any Extended Device Description.

It is mandatory for a device application to provide a Simple Device Description to the HUCL Stack when requested. A device that does not provide any Extended Device Description can ignore any requests it receives for such information.

Included in the Simple Device Description returned by a device (when requested) is the device type field 232 that identifies the type of the device, e.g. TV, DVD, Light Fitting etc. The Device Type field 232 will identify to the controller (requesting the Simple Device Description) the instruction set that the device conforms to HUCL devices identify themselves simply by their type identifier, they do not then go on to send messages to describe how they are controlled; there is no ‘runtime’ service description concept in HUCL. If a device identifies itself as a light fitting then the command set that can be called on this device is identified on paper in the HUCL specification for a Light Fitting type device.

Referring to FIG. 4, all device types depend from a base device type 50. Top level elements 58 include in this example the controller device type 52, a basic device type 54 for controlled devices and an alarm device type 56.

Subsidiary device types 68 depend from the basic device type. In the example, these include a TV device type 64, a dimmable light device type 62 and a PVR device 60.

The Device Type Classification was to produce a system aims to allow a simple controller to identify whether it could control a device to the extent of the controllers' capabilities.

A simple switch could be paired with a light fitting to turn on and off a light, but one might argue that the control functionality of the switch, that is its ability to turn a device on or off should be applicable to any device than can accept an on/off concept e.g. a TV, Heater, Printer.

One way in which this could be implemented is for the switch to have a list of all of the devices it knows how to control (turn On or Off), so when it requests the Simple Device Description for a device, it can look at the Device Type field in the returned description and determine if it is within its list of device types it knows how to control.

There are two significant drawbacks of this approach, firstly the switch is a very simple device and it is undesirable for the application within it to have to hold a list of all possible devices that it could control, which would be quite large; secondly if a new type of device is created after the switch is produced (which can accept simple On Off functionality), then the switch will not have this new device type in its list, and will not believe it can control it i.e. it is not extensible.

HUCL classifies devices in a hierarchical way, shown in FIG. 4. The Device Type field 232 (FIG. 15) identifies the device within the hierarchy and so even if new devices were created, as long as it is derived from an the appropriate point within the hierarchy, a simple switch would still know that it could control it to an extent.

Devices that fall lower in the tree inherit the functionality of device types above it. It may be necessary to add some interpretation to the commands when applied to lower devices in the tree, for example the On/Off command when sent to a light will fairly obviously turn it On and Off, but the same commands when sent to a TV would place it in and out of standby mode.

The key benefit of the Device Type description is that even if the controller has no knowledge of the specific device type itself, it can determine the device from which it is derived, of which it may have some knowledge and hence may be able to control the device to some lesser extent (from the perspective of the device).

For example, consider the case that a light switch obtains the address of a device, it requests from this device the Simple Device Description; the Device Type field identifies the device as TV, but the switch does not recognise this as a device it knows about. However the switch can also establish from the description that it is a derivative of the ‘Basic Device’, which it does know about. The net result is that the switch can control the TV, to the extent of the controllers capabilities i.e. On and Off, despite knowing nothing about the device itself. The device could be a brand new category of device called an ‘XYZ’ invented long after the switch was manufactured, but so long as it is derived from a Basic Device the switch can still control it to an extent.

Although the Device Type Hierarchy may have just two tiers, and controller and basic device top level elements, at least one further tier and/or top level element is desirable. This caters for devices that would not comply with the functionality shown above in the Basic Device that is devices that do not have basic ‘Turn On’ ‘Turn Off’ functionality, e.g. an alarm. For illustrative purposes an ‘Alarm’ type device 56 has been shown in FIG. 4 and understandably this ‘Alarm’ device does not want to implement the normal On/Off functions that devices that are derived from Basic Device must have; it therefore sits at the same top level 58 in the hierarchy as the Basic Device 54 itself.

A second extension to the hierarchy is also shown in FIG. 4 i.e. the Enhanced TV Device 66 below the normal TV Device 64. Here the Enhanced TV Device inherits all of the functionality of both the Basic Device 54 and the TV Device 64, but also includes some extended functionality that is not present in a normal TV. A regular TV remote control designed to operate a normal TV Device can operate the Enhanced TV Device to the level of a normal TV Device functionality, but can't control the extended functionality.

The HUCL protocol accordingly provides an extensible mechanism for describing the Device Type and the devices above it from which it inherits functionality. Whilst the idea of a hierarchy of many layers might seem appealing, extending it beyond three or four levels will start to impact the size of the Simple Device Description.

Within HUCL it is possible to request a device description from a controller as well as a controllable device. When one device sends the “Get Simple Description” to a controller device (e.g. a switch) it is returned a Simple Device Description that contains a Device Type of “Controller”. The controller device may also make available an Extended Device Description which provides further information such as the manufacturer, model number etc.

It is important to note that the Device Type returned by a controller device is simply “Controller” 52 there is no hierarchy of different controller type devices defined in the device type tree. The reason for this is again trying to keep the protocol and messages sizes small and simple. It might be felt that it would be possible to have different controller types derived from the basic Controller such as a Switch, TV Remote Control, PVR Remote Control, etc. However a problem would occur with intelligent controllers such as Universal Remote Controller that are capable of controlling a wide range of devices. To include all of the possible controller types in a simple device description would result in a potentially large message, which goes against the ideal of trying to make the initial Simple Device Description simple. To determine the exact capabilities of a controller device different mechanisms are employed.

The first means of determining the capabilities of a controller device is by the Extended Device Description which is permitted on a controller device and may contain information such as the device name e.g. “Universal Remote Control” and whilst this is textual information and is not directly interpretable by application software, it can be presented to the user to assist in making an informed choice about a controller.

The second means for a device to determine more about a controller is by querying it.

The use of querying is a powerful mechanism for drip-feeding information about a device that would otherwise, if supplied en-mass, overload the requestor.

Each device of controller type provides a means for other devices to query 120 whether it is able to control a specific Device Type (FIG. 5). The device type passed in the query is the same field as is used in the Simple Device Description i.e. as defined in the Device Type Hierarchy. The controller returns 122 the level to which it can control the device, by returning the lowest device type in a list stored in the controller memory 14 that is the device type passed in the query or from which that device type depends. For example, a simple switch is queried whether it can control an Enhanced TV Device. Based on the hierarchy illustrated in FIG. 4 above the reply is that it can control it to the level of Basic Device. The switch would typically itself know nothing about a device type of Enhanced TV Device, but since the Device Type also includes the inherited devices it would be able to identify the Basic Device and return this as the lowest hierarchically superior device type it is capable of controlling.

The controller also implements an algorithm to determine if the switch can control a device type that is returned to it in a Simple Device Description (FIG. 6). When a switch discovers the address of a device it asks 124 the device for its simple device description, on receiving this information 126 the switch tests 128 whether it can control a device of this type to any degree, which is the same question it needs to respond to as a result of the querying process 120. The result is that the two query processes 120, 122, 124, 126, 128 do not add too much to the complexity of the simple switch device. The same applies to other simple devices.

It can be foreseen that there will be instances where a device may be a composition of a number of discrete devices all accessed via the same physical address e.g. all co-located on a single RF transceiver.

Examples of this type of device are a bank of individually switchable lights controlled through a single RF transceiver, or a TV with integrated alarm clock where both components are remotely controllable again through the same transceiver.

FIG. 7 illustrates the discovery process. The switch initially obtains the addresses of all devices known by the underlying transport medium, this includes the single address of the four individually controllable lights. The switch issues 140 a Get Simple Description command to the light bank, and the question that arises is what should the reply be? If four device descriptions are returned then this would be four times as much data than the switch would be expecting to receive. Returning multiple Simple Device Descriptions is not very scalable, and would, for example cause problems if there were 20 lights in the lighting bank.

The solution for this provided by HUCL is a specific Device Type for composite devices.

The composite device returns 142 its Simple Device Description including in the Device Type field 232 its device type as a “Composite Device”. The Simple Device Description also identifies in field 234 that there are, in this example, four embedded devices within this single device.

The next stage once the controller has identified that it is communicating with a composite device is for it to establish what devices are embedded within it. The controller makes 144 further Get Simple Description requests to the composite device but addressing the requests to the specific embedded devices. The embedded devices return 146 their device descriptions.

Once the controller decides that it is going to control one of the embedded devices, all control commands are directed at the specific embedded device by including an embedded device ID with each command. Once the concept of the composite device has been established it opens up the possibility for a number of interesting device combinations that would be of benefit, some of these will be discussed below.

An example is a single device that consists of a lamp with integral switch, where the functionality of switch is exposed so as to be able to control other devices. This device, when queried for its Simple Device Description exhibits itself as a composite device, but when queried further one embedded device would be found to be a controller, and the other a controllable i.e. a Light Device. A number of such devices could be configured in such a way that operating the switch on any one of the devices causes the lights to be turned On/Off on all the devices e.g. turning on any one table lamp in the lounge causes all the table lamps in the lounge to come on.

Other possible combinations of composite device within the CE domain include for example a TV+video cassette recorder (VCR) or DVD and VCR. Each of these could if required describe itself as a composite of two devices.

Conceptually a Device consists of the core device plus zero or more sub-components, e.g. a TV Device 60 may for example consist of the TV Device 60 itself plus Tuner 64, Audio 66 and Display 68 sub-components (see FIG. 8).

It is also conceivable that a single device may have more than one instance of a sub-component e.g. a TV/VCR Combi Device may have two tuners 62, 64, one for the TV and one for the VCR (see FIG. 9), as well as audio 66 and display 68 components.

It might be felt that the use of XML and its compression and de-compression on the simplest of devices is a little heavyweight. The use of XML to describe the protocol provides a solution that is easily extensible for future enhancements, relatively simple to describe and understand, can easily handle structured information and is instantly compatible with the ‘internet domain’.

Using a tagged compression technique on the XML (defined within HUCL) takes the relatively verbose protocol back down in size towards that of a traditional pure binary-based protocol, with some additional overhead to retain the content structure.

If one were to be presented with the a command in its compressed form it can be read in a similar manner that one would read any other binary based protocol, using information on the command structure and a table of definitions for data values. The only hint that the binary data may have originated from an XML based notation would be the presence of data to represent structure.

The HUCL specification defines that the messages is always transmitted through the transport medium in its compressed form. However on a simple device the application may operate directly on compressed messages, so eliminating the need on that device for the presence of the compression/de-compression software within the HUCL Software Stack. In this case the application would store (as part of the application image in ROM) the simple device description in its pre-compressed form, it would have a parser for the compressed protocol messages that it receives which would be similar in nature to any other binary protocol parser; any response messages would also need to be stored in their compressed form.

Using this approach the simplest devices such as the light switch and light fitting example used throughout this section can be implemented with a reduced software stack, and given that the number of commands that a simple device would need to understand and send is relatively small (turn light on, turn light off, toggle, get current state, get device description etc.) the overhead on the application software is minimal.

This offers a scalable solution to devices, where it is practical to implement the application to operate on compressed data this can be done, but when the device becomes more complex there will be a point where it becomes easier to include the compression/de-compression functionality in the stack and have the application use the protocol messages in their full XML notation. This cut off point is entirely down to the device designer and not defined or dictated by HUCL at all.

FIG. 10 illustrates how the components that make up HUCL fit together. It will be appreciated that the components are software components recorded in memory.

The following sections discuss in more detail the layers that form the HUCL software stack 32 and the functionality that they provide.

As has been stated earlier HUCL does not rely on a specific transport protocol (unlike for example TCP/IP) but instead sits directly on top of a transport stack 34. Different transport stacks 34 will by their nature offer differing services to applications and through differing API's; the HUCL Transport Adaption Layer 180 acts as a buffer to the specific transport layer.

The Transport Adaption Layer 180 provides to the higher layers in the HUCL stack a consistent transport independent set of services. The requirements of this layer are defined in detail in the Protocol Specification.

The messaging layer 182 provides the bulk of the functionality of the HUCL Software Stack. Applications communicate with this layer through the HUCL API and it will perform the calls back in to the application when necessary (e.g. when data is received).

The messaging layer 182 also handles any initial error reporting and if necessary acknowledgements. Message ID's and Transaction ID's used to check for missing messages and for coupling messages to replies are also handled fully by this layer.

The Messaging layer 182 also makes use of the Compression/Decompression services 184 as and when a message needs to be compressed or decompressed. As discussed earlier an application deals exclusively with messages in their compressed form, no calls are made to these services and they can be removed from the runtime stack.

Quite simply the compression and decompression services provide the message layer with the means to convert the HUCL messages between their compressed and decompressed forms. It is possible for this component of the system to be absent in low-end devices where all data exchanges with the application are made with compressed messages.

The application programming interface API 186 is the interface through which all applications communicate with the HUCL software Stack. Communication is bi-directional in that the HUCL stack will make asynchronous calls back to the application as a result of certain events occurring in the lower layers e.g. message received via the transport stack.

HUCL is transport stack 34 independent, and what this means is that the HUCL messaging protocol can be built on top of a variety of transport stacks, both wired and wireless.

Since HUCL is designed as a lightweight protocol it is therefore most suited to lightweight transport stacks as well such as the emerging Zigbee (802.15.4) standard, but it can sit equally well on top of TCP & UDP/IP which opens up a wide range of other protocols, both wired (e.g. Ethernet) and wireless (e.g. 802.11b).

For a HUCL to be implemented on a transport stack 34 it must be possible to provide a number of services to the messaging layer of the HUCL stack. This means that these services can either be present in the transport stack itself or it must be possible to implement any missing services in the Transport Abstraction Layer of the HUCL stack. These services may cover aspects such as addressing, message delivery and device discovery (e.g. discovering the addresses of other devices on the network).

Bridging will now be described, with particular reference to HUCL. However, the principles of the invention are not limited to HUCL and may be applied in other network protocols.

Bridging between different networks is an important part of any protocol. There is never going to be a single network protocol and transport medium adopted universally.

From the perspective of HUCL there are two distinct types of bridging possible; firstly that between different transport stacks where HUCL is the common protocol being used on both, and secondly bridging between different protocols.

HUCL transport stack bridging is necessary when a number of HUCL devices exist that need to communicate with each other but that use different underlying transport stacks or networks 210, 212. The illustration below highlights one such example.

FIG. 11 above shows a scenario according to the invention where a number of devices 200 all use the HUCL protocol. Some of these devices 202 operate over Zigbee 210 and others 204 operate over 802.11b 212, so whilst all the devices ‘speak the same language’ (HUCL) the Zigbee devices 202 are unable to communicate directly with the 802.11b 204 devices because of the different transport network.

The bridge in this situation consists of a bridge device 206 with both a Zigbee and 802.11b transceiver, on top of these the HUCL bridge software resides. Since the whole network is all based on HUCL the job of the bridge is primarily that of a router. The bridge has a first transceiver 224 for communicating with devices in the Zigbee network 210 and a second transceiver 226 for communicating with devices in the second network 212. Although only one device 202 other than the bridge 206 is shown in the first network, there may of course be many more devices.

The use of the composite device type can greatly simplify a bridge in HUCL. At the lowest level the bridge appears on each of the networks as a single physical address. When a device discovers the bridge address it first, as always, requests device information through the Get Simple Description request. The bridge responds directly to this and identifies itself as a Composite Device and returns the number of devices located on the ‘other side’ of the bridge.

Further queries are then made to the bridge requesting the Simple Device Description for each of the ‘pseudo’ embedded devices, just as if it were any other composite device. The requests and subsequent commands are all identified as being for a specific embedded device within the bridge however they are then forwarded on by the bridge to a specific device located on the ‘other side’.

The bridge is not quite a normal composite device since the number of embedded devices that it contains may change; it is a Dynamic Composite. The bridge identifies the number of embedded devices as a part of the standard response to a Get Simple Description request, but this is the instantaneous number of devices located on the other side of the bridge. The Dynamic Composite also exposes an attribute that identifies the number of devices on the other side, so that devices can query this at any time. If the bridge supports event subscription, devices can also subscribe to changes in this attribute so as they are informed when the number of devices changes.

A Home Gateway that would allow devices within a home network to be controlled from outside would be implemented as a type of bridge. The scenario illustrated in FIG. 12 shows a gateway 220 connected to the outside world via a wired IP based transport, and connecting devices in the home on both Zigbee 210 and 802.11b 212.

Commands and requests from the outside IP domain 222 are directed to the Home Gateway using a conventional IP address scheme (IPv4 or IPv6), once they arrive the devices within the home are represented as embedded devices contained within the Gateway, and commands and requests are directed to these via the normal mechanism used on any composite device. Internally the Gateway has a table mapping the embedded device number with real device addresses located on one of the two possible networks. The Gateway then forwards on requests to the correct device.

The second distinct type of bridging is that of Protocol Bridging where the protocol itself (and possible the transport medium) is different on two or more networks. This is illustrated with in FIG. 13. The Protocol Bridge 220 can understand the messages and convert them from one protocol to the other. However, the use of the composite device concept to present devices to the HUCL network that are physically present on the other protocol may be used as above.

It is intended that HUCL shall adopt the addressing scheme of the underlying transport stack. By doing this the complexity of devices and the sizes of messages can be kept to a minimum. Only the bridge type devices require an address table.

The protocol itself is a document recorded on a medium 214, including the following information as shown in FIG. 14:
a generic HUCL message format 200 that defines the format to which all HUCL messages conform;
message definitions 202 defining the specific messages that form the control protocol.
message sequencing requirements 204 defining which messages are sent when, and the requirements of the application on receiving a message.
the HUCL API definition 206 defining the bi directional interface between HUCL and the application using it;
the messaging System requirements and functionality 208 of the HUCL software stack;
a compression algorithm 210 defining the mechanism for the compression of the HUCL messages, and a transport Adaption Layer definition 212 defining how the HUCL software stack is interfaced to a transport system (e.g. an RF stack).

HUCL is accordingly not simply a message format definition but also encapsulates a message interchange and compression. The later four items in the list above form the HUCL software stack that would be present in a device, the first three items define the requirements to which the stack and application must conform.

From reading the present disclosure, other variations and modifications will be apparent to persons skilled in the art. Such variations and modifications may involve equivalent and other features which are already known in the design, manufacture and use of networks and which may be used in addition to or instead of features described herein. Although claims have been formulated in this application to particular combinations of features, it should be understood that the scope of disclosure also includes any novel feature or any novel combination of features disclosed herein either explicitly or implicitly or any generalisation thereof, whether or not it mitigates any or all of the same technical problems as does the present invention. The applicants hereby give notice that new claims may be formulated to any such features and/or combinations of such features during the prosecution of the present application or of any further applications derived therefrom.

In particular, although a specific HUCL protocol has been described, the invention may be used with any network which has, or may be arranged to include, a device type corresponding to the composite device type.

The specific subroutine names used in the examples may readily be varied. The computer program controlling the devices is shown as being recorded in memory 14 but the skilled person will realise that it could be recorded on many other types of record carrier such as a CD, floppy disc, etc.

Further, it will be noted that a very simple example of a light fitting and light switch has been extensively described in the forgoing. The skilled person will appreciate that many more complex control scenarios are also possible.

Although the above descriptions of a bridge device assume that the bridge device is a single device, the skilled person will realise that with some networks it may be convenient to implement a separate physical device in each network, and link the devices together possibly using a third device. Such composite bridge components are intended to be included within the scope of the term “bridge device” as used herein.

1. A method of operating a bridge device between first and second networks, there being a plurality of first network devices (202) in the first network, a plurality of second network devices (204) in the second network, one of the network devices being a bridge device (206) in both the first and second networks, wherein the first network uses message signals (230) including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice; the method including:
receiving a device description query in the bridge device (206) from the first network (210);
responding to the device description query with a device description message (230) including the description of the bridge device as being of a composite device type and a value representing the number of other devices in the second network;
receiving at least one further device description query from a device (202) in the first network (210) relating to one of the other devices (204);
responding to the or each further device description query with a device description message including a description of the other device (204); and
forwarding in the first network (210) further messages to or from devices (204) in the second network from or to devices (202) in the first network respectively as messages to or from the respective subdevice of the bridge device, so that network devices (204) in the second network appear to network devices (202) in the first network as sub-devices of the bridge device (206) of composite device type.

2. A method according to claim 1 wherein the number of devices in the second network changes and the value representing the number of devices in the second network represents the instantaneous value of devices in the second network.

3. A method according to claim 1 or 2, further including:
receiving a device description query in the bridge device (206) from the second network;
responding to the device description query with a device description message (230) including the description of the bridge device as being of a composite device type and a value representing the number of other devices (202) in the first network;
receiving at least one further device description query from a device (204) in the second network relating to one of the other devices (202);
responding to the or each further device description query with a device description message including a description of the other device (202); and
forwarding in the second network further messages to or from devices (202) in the first network from or to devices (204) in the second network respectively as messages to or from the respective subdevice of the bridge device;
whereby network devices (202) in the first network appear to network devices (204) in the second network as sub-devices of the bridge device (206) of composite device type.

4. A bridge device between first and second networks, there being a plurality of first network devices (202) in the first network, a plurality of second network devices (204) in the second network, wherein the first network uses message signals (230) including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice; the bridge device comprising:
a transceiver (224) for communicating with other devices in the first network;
a transceiver (226) for communicating with other devices in the second network;
and a message handler (182) arranged:
to receive a device description query in the bridge device from the first network and to respond to the device description query with a device description message (230) including the description of the bridge device as being of a composite device type and a value representing the number of other devices in the second network;
to receive at least one further device description query from the first network relating to one of the other devices (204); and to respond to the or each further device description query with a device description message including a description of the other device (204) as a corresponding sub-device; and
to forward in the first network (210) further messages to or from devices (204) in the second network from or to devices (202) in the first network respectively as messages to or from the respective subdevice of the bridge device;
whereby network devices in the second network appear to network devices in the first network as sub-devices of the bridge device (206) of composite device type.

5. A bridge device according to claim 4 wherein the number of devices in the second network is not constant and the bridge is arranged to respond to a device description query from the first network with the instantaneous number of devices in the second network.

6. A bridge device according to claim 4 or 5 wherein the message handler (182) is arranged:
to receive a device description query in the bridge device from the second network and to respond to the device description query with a device description message (230) including the description of the bridge device as being of a composite device type and a value representing the number of other devices (202) in the first network;
to receive at least one further device description query from the second network relating to one of the other devices (202); and to respond to the or each further device description query with a device description message including a description of the other device (202) as a corresponding sub-device; and
to forward in the second network (210) further messages to or from devices (202) in the first network from or to devices (204) in the second network respectively as messages to or from the respective subdevice of the bridge device;
whereby network devices in the second network appear to network devices in the second network as sub-devices of the bridge device (206) of composite device type.

7. A system comprising:
a first network including a plurality of first network devices (202), wherein the first network uses message signals (230) including device descriptions of the network devices as being of one of a number of device types including a composite device type having a plurality of subdevices and wherein devices in the first network find further information regarding composite devices by sending further device queries relating to an individual subdevice and receiving from the composite device information relating to the individual subdevice;
a second network including a plurality of second network devices (204);
wherein one off the network devices is a bridge device (206) in both the first and second networks; the bridge device comprising:
a first transceiver (224) for communicating with other devices in the first network;
a second transceiver (226) for communicating with other devices in the second network;
and a message handler (182) arranged:
to receive a device description query in the bridge device from the first network and to respond to the device description query with a device description message (230) including the description of the bridge device as being of a composite device type and a value representing the number of other devices in the second network;
to receive at least one further device description query from the first network relating to one of the other devices (204); and to respond to the or each further device description query with a device description message including a description of the other device (204) as a corresponding sub-device; and
to forward in the first network (210) further messages to or from devices (204) in the second network from or to devices (202) in the first network respectively as messages to or from the respective subdevice of the bridge device;
whereby network devices in the second network appear to network devices in the first network as sub-devices of the bridge device (206) of composite device type.

8. A system according to claim 7 wherein the number of devices in the second network is not constant and the bridge device (206) is arranged to respond to a device description query from the first network with the instantaneous number of devices in the second network.

9. A system according to claim 7 or 8 wherein the second network uses message signals (230) including device descriptions of the network devices as being of one of a number of device types including a composite device type having a plurality of subdevices and devices in the second network find further information regarding composite devices by sending further device queries relating to an individual subdevice and receiving from the composite device information relating to the individual subdevice;
wherein the message handler (182) is arranged:
to receive a device description query in the bridge device from the second network and to respond to the device description query with a device description message (230) including the description of the bridge device as . . . being of a composite device type and a value representing the number of other devices (202) in the first network;
to receive at least one further device description query from the second network relating to one of the other devices (202); and to respond to the or each further device description query with a device description message including a description of the other device (202) as a corresponding sub-device; and
to forward in the second network (210) further messages to or from devices (202) in the first network from or to devices (204) in the second network respectively as messages to or from the respective subdevice of the bridge device;
whereby network devices in the second network appear to network devices in the second network as sub-devices of the bridge device (206) of composite device type.

10. A computer program arranged to control a networked bridge device to carry out the method of claim 1, 2 or 3.

11. A computer program according to claim 10 recorded on a data carrier.
